(19) United States
(12) Patent Application Publication
(10) Pub. No.: US 2014/0162150 A1
(43) Pub. Date: Jun. 12, 2014

(54) HUMIDIFYING APPARATUS AND METHOD OF FUEL CELL

(71) Applicant: HYUNDAI MOTOR COMPANY, Seoul (KR)

(72) Inventors: Hyunyoo Kim, Seoul (KR); Hyuck Roul Kwon, Yongin, Gyeonggi-do (KR)

(73) Assignee: HYUNDAI MOTOR COMPANY, Seoul (KR)

(21) Appl. No.: 14/081,232

(22) Filed: Nov. 15, 2013

(30) Foreign Application Priority Data
Dec. 12, 2012 (KR) 10-2012-0144857

(51) Int. Cl. H01M 8/04

(52) U.S. Cl. CPC H01M 8/04149
USPC 429/413; 429/535

(57) ABSTRACT

A humidifying apparatus of a fuel cell is provided that includes a housing, a hollow fiber membrane module, valve, a sensor, and a controller. More specifically, a hollow fiber membrane module is disposed inside a housing. This housing has a first inlet and a first outlet formed in both side surfaces of an outer circumferential surface of the housing, and a second inlet and a second outlet formed at one side and an opposite side of the housing. Additionally, a valve is mounted in the first outlet of housing and a sensor is configured to sense a control factor of a fuel cell stack. A controller is also configured to output a control signal to adjust how much the valve is opened or closed according to a sensing signal from the sensor.

### CROSS-REFERENCE TO RELATED APPLICATION

This application claims priority to and the benefit of Korean Patent Application No. 10-2012-0144857 filed in the Korean Intellectual Property Office on Dec. 12, 2012, the entire contents of which are incorporated herein by reference.

### BACKGROUND

(a) Field of the Invention

The present invention relates to a humidifying apparatus and method of a fuel cell, and more particularly, to a humidifying apparatus and method of a fuel cell in which a flow path opening/closing valve, of which opening/closing is adjusted according to output of the fuel cell, is installed at a center portion of a hollow fiber membrane module.

(b) Description of the Related Art

In general, a fuel cell that is applied to a fuel cell vehicle includes an electrical generation assembly in which a plurality of unit cells are continuously arranged, and each unit cell generates electrical energy via an electrochemical reaction between a fuel (e.g., hydrogen) and an oxidant (e.g., air).

Each unit cell includes a membrane-electrode assembly, and separators disposed so as to be in close contact with both sides of the membrane-electrode assembly, respectively. The separator is conductive in nature and is typically shaped like a plate. The separator also includes channels, through which fuel and the oxidant flow along a surface in close contact with the membrane-electrode assembly, respectively.

The membrane-electrode assembly includes an anode electrode (hereinafter, referred to as an “anode” for convenience) formed on one surface and a cathode electrode (hereinafter, referred to as a “cathode” for convenience) formed on the other surface. Additionally, an electrolyte membrane is formed between the anode and the cathode. Electrons are drawn from the anode to the cathode through an external circuit, producing direct current electricity.

At the anode a catalyst oxidizes the fuel supplied through the channel of the separator to separate the fuel into negatively charged electrons and a positively charged ion (usually hydrogen ions). The electrolyte membrane is a substance specifically designed so ions can pass through it, but the negatively charged electrons cannot. The freed electrons travel through a wire that in turn creates an electric current. The positively charged ions travel through the electrolyte to the cathode. Once reaching the cathode, the positively charged ions are reunited with the electrons and the negatively charged electrons and positively charged ions received from the anode react with oxygen contained in the oxidant received through the channel of the separator. This reaction typically results in the creation of water or carbon dioxide and heat.

Additionally, in order to efficiently and effectively operate the aforementioned fuel cell, the electrolyte membrane of the stack needs to be maintained at a proper humidity. To do so, air supplied to the fuel cell is humidified at an air inlet via a humidifier.

On type of humidifier that is typically applied to fuel cell vehicles is a membrane humidifier that is configured such that a hollow fiber membrane module, in which a plurality of hollow fiber membranes is densely collected, is disposed inside a housing. Furthermore, a first inlet and a first outlet through which dry air passes are formed at both side surfaces of the housing, and a second inlet and a second outlet through which wet air passes are formed on an upper side surface of the housing.

Operationally, as dry air is introduced through the first inlet to pass through an internal side of the hollow fiber membrane module, wet air is supplied through the second inlet toward an external side of the hollow fiber membrane module. Moisture contained in the wet air is separated by a capillary action of the hollow fiber membrane, and the separated moisture is condensed while passing through the inside of a capillary tube of the hollow fiber membrane to move inside the hollow fiber membrane. As a result, the dry air introduced through the first inlet is humidified by the moisture within the membrane, and humidified air is exhausted through the first outlet.

However, in conventional membrane humidifiers, since the hollow fiber membranes are densely collected in the hollow fiber membrane module, the wet air introduced through the second inlet cannot permeate into the hollow fiber membrane module. Additionally, the speed at which the wet air is diffused to the inside of the hollow fiber membrane module is very slow, and the inside of the hollow fiber membrane module fails to sufficiently receive moisture.

Accordingly, most of the dry air flows toward a center portion of the hollow fiber membrane module, and the wet air flows toward an edge of the hollow fiber membrane module. Thus, the efficiency of the humidifying apparatus considerably deteriorates.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a humidifying apparatus and method of a fuel cell, which is capable of improving humidifying performance using an entire hollow fiber membrane module, is capable of reducing the amount of usage of the number of strands of a hollow fiber membrane, has an advantageous packaging, and is capable of reducing the pressure drop applied to the humidifying apparatus and load of an air blower during high output of the stack.

An exemplary embodiment of the present invention provides a humidifying apparatus of a fuel cell includes a hollow fiber membrane module disposed inside a housing, the housing being provided with a first inlet and a first outlet formed in both side surfaces thereof, and a second inlet and a second outlet formed at one side and the other side of an outer circumferential surface thereof. Additionally, a flow path opening/closing valve is mounted in the first outlet, and a sensor is configured to sense a control factor of a fuel cell stack. A controller is configured to output a control signal to adjust when and for how long the flow path opening/closing valve is opened or closed based up on a sensing signal from the sensor.

The control factor may include any one of the amount of output current of the fuel cell stack, the amount of applied pressure on an accelerator pedal, and humidity of the inlet of the fuel cell stack.

Additionally, in some exemplary embodiments of the present invention, the flow path opening/closing valve may be embodied as a solenoid valve employing a duty control method.

The controller, in the exemplary embodiment, may output a control signal associated with a low-output range when output of the fuel cell is less than about 30 kw, a control signal of an intermediate-output range when output of the fuel cell is about 30 to 60 kw, and a control signal of a high-output range when output of the fuel cell is about 60 to 100 kw, based on 100 kw of output of the fuel cell.

Further, the controller may include control logic for completely closing the flow path opening/closing valve upon receiving a control signal associated with a low-output range to make dry air flow toward an outer side of the hollow fiber membrane module. The controller may also include control logic in which the amount at which the flow path opening/closing valve is opened is duty-controlled according to the control signal of the intermediate-output range. Furthermore, the controller may also include control logic for completely opening the flow path opening/closing valve upon receiving a control signal associated with a high-output range to force the dry air flow toward the entire hollow fiber membrane module.

Further, the sensor may include any one among a current sensor configured to sense the amount of output current of the fuel cell stack, a pedal sensor configured to sense the amount of applied pressure of the accelerator pedal, and a humidity sensor configured to sense humidity of the inlet of the fuel cell stack.

Another exemplary embodiment of the present invention provides a humidifying method of a fuel cell, including: disposing a hollow fiber membrane module, in which a plurality of hollow fiber membranes are densely collected, inside the housing, forming a first inlet and a first outlet in both side surfaces of the housing, forming a second inlet and a second outlet at both sides of an outer circumferential surface of the housing, mounting a flow path opening/closing valve in the first outlet, and adjusting by a controller an amount of that the flow path opening/closing valve is opened according to a sensing signal that is received from a sensor that is sensing a control factor of the fuel cell stack to adjust humidity of the fuel cell stack.

Advantageously, according to the exemplary embodiment of the present invention, the flow path opening/closing valve is mounted in the outlet of the dry air, and the opening/closing of the flow path opening/closing valve is controlled according to an output condition of the stack, thereby improving humidifying performance with the entire hollow fiber membrane module. Further, according to the exemplary embodiment of the present invention, it is possible to decrease the amount of strands of the hollow fiber membranes that are used within the hollow fiber membrane module, improve price competitiveness, and reduce the overall size of the package.

Additionally, according to the exemplary embodiment of the present invention, it is possible to decrease the pressure drop applied to the humidifying apparatus adjustably opening and closing the flow path via a flow path opening/closing valve when the fuel cell stack has a high output, and reducing load on an air blower through a decrease in pressure drop.

### BRIEF DESCRIPTION OF THE DRAWINGS

FIG. 1 is a cross-sectional side view of a humidifying apparatus of a fuel cell according to an exemplary embodiment of the present invention.

FIG. 2 is a control configuration diagram of the humidifying apparatus of the fuel cell according to an exemplary embodiment of the present invention.

FIGS. 3A to 3C are views of implementation of the humidifying apparatus according to an exemplary embodiment of the present invention.

### DETAILED DESCRIPTION OF THE EMBODIMENTS

Hereinafter, an exemplary embodiment of the present invention will be described in detail with reference to the accompanying drawings.

Before this, the exemplary embodiments described in the present specification and the configuration illustrated in the drawings are simply the exemplary embodiments of the present invention, and do not represent all of the technical spirits of the present invention, and thus it should be understood that there are various equivalents and modification examples substitutable with the exemplary embodiments described in the present specification and the configuration illustrated in the drawings at the time of filing the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below control logic and control methods are executed by at least one controller. The term controller refers to a hardware device that includes a memory and a processor and is thus a tangible structure defined by structurally by the control logic which it is configured to execute. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The features of the present invention will now be described in detail below.

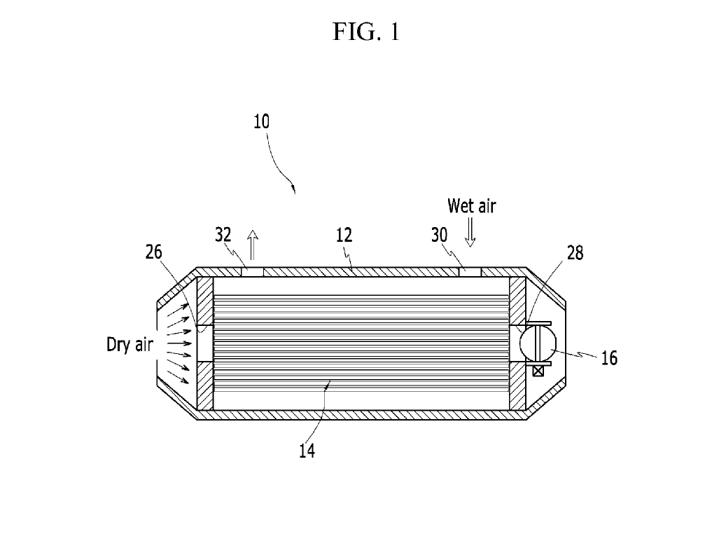

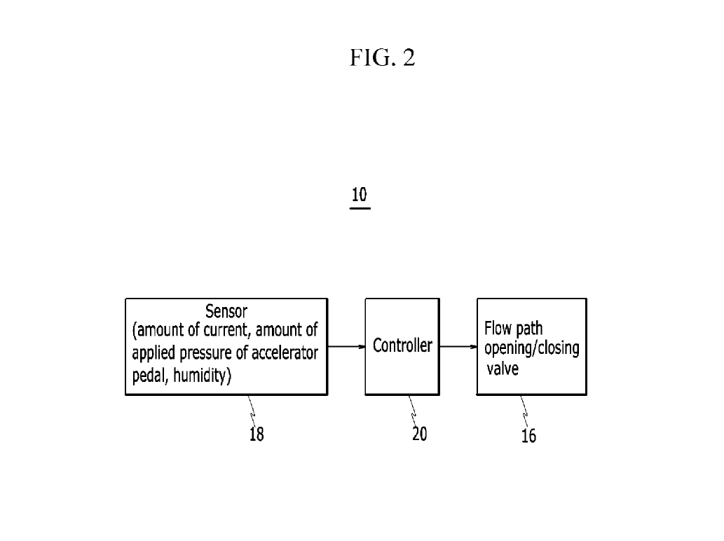

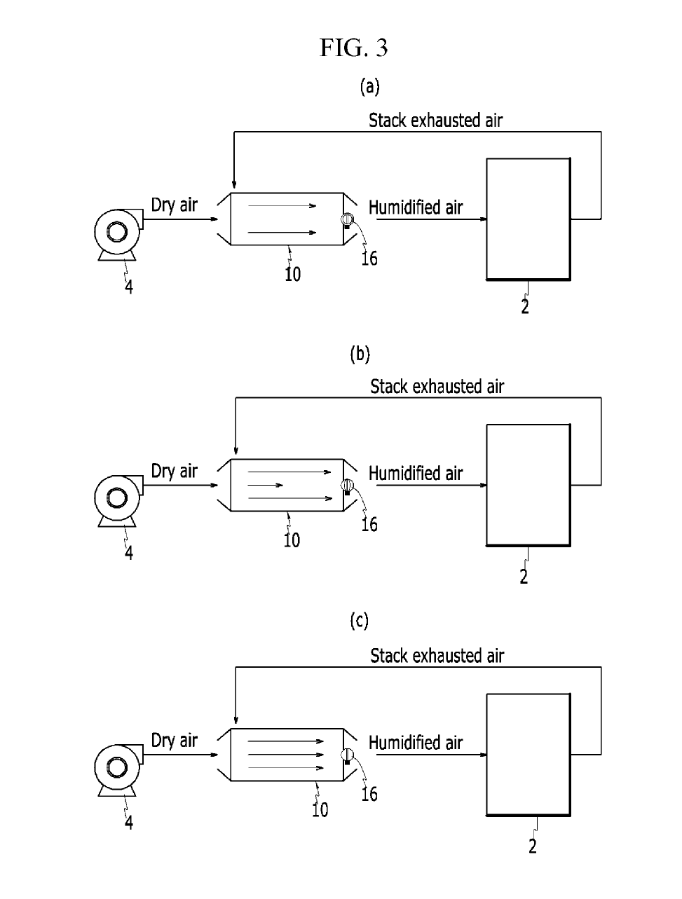

FIG. 1 is a cross-sectional side view of a humidifying apparatus of a fuel cell according to an exemplary embodiment of the present invention, FIG. 2 is a control configuration diagram of the humidifying apparatus of the fuel cell according to an exemplary embodiment of the present invention, and FIGS. 3A to 3C are views of implementation of the humidifying apparatus according to an exemplary embodiment of the present invention.

The humidifying apparatus 10 of the fuel cell according to an exemplary embodiment of the present invention illustrated in FIG. 1 includes a housing 12, a hollow fiber membrane module 14, a flow path opening/closing valve 16, a sensor 18, and a controller 20.

The housing 12 of the humidifying apparatus 10 may be formed in a cylindrical shape, and have a first inlet 26 and a first outlet 28 that are formed on both side surfaces of the housing 12, respectively. More specifically, the first inlet 26 and the first outlet 28 may be formed as the inlet and the outlet through which dry air passes. The dry air may flow to a center portion of the hollow fiber membrane module by using the first inlet 26 and the first outlet 28 as the inlet and the outlet.

Further, a second inlet 30 and a second outlet 32 may be formed on one side and an opposing side of an outer circumferential surface of the housing 12, respectively. The second inlet 30 and the second outlet 32 may be formed as the inlet and the outlet through which wet air passes. The wet air may move to an external side of the hollow fiber membrane module by using the second inlet 30 and the second outlet 32 as the inlet and the outlet. As such, the hollow fiber membrane module 14 may be disposed inside the housing 12 in a lengthwise direction. In doing so, a bundle of hollow fiber membranes is densely collected so that the hollow fiber membrane module 14 is configured accordingly.

Furthermore, the flow path opening/closing valve 16 is mounted in the first outlet 28 through which dry air is exhausted. The flow path opening/closing valve 16 illustrated in FIGS. 1 and 3 is illustrated as rotating at 90 degrees for convenience of description. As illustrated in FIGS. 1 and 3, the flow path opening/closing valve 16 may be embodied as a solenoid valve employing a duty-control method in which the valve is opened according to an output value of the fuel cell stack 2.

As illustrated in FIG. 2, the sensor 18 of the humidifying apparatus 10 senses a control factor. This control factor may include either the amount of current of the fuel cell stack 2, the amount of applied pressure of an accelerator pedal, or humidity of the inlet of the fuel cell stack 2. As such, the sensor 18 may be embodied as a current sensor for sensing the amount of current of the fuel cell stack 2, a pedal sensor for sensing the amount of applied pressure on the accelerator pedal, or a humidity sensor for sensing humidity of the inlet of the fuel cell stack 2. These signals generated by the sensor 18 are then sent to the controller 20.

The controller 20 outputs control signals associated with a low-output range, an intermediate-output range, and a high-output range according to a sensing signal of the sensor 18. For example, in the exemplary embodiment of the present invention, based on the output of 100 kw of the fuel cell, a range having less than about 30 kw may be classified as the low-output range, a range having about 30 to 60 kw may be classified as the intermediate-output range, and a range having about 60 to 100 kw may be classified as the high-output range.

As such, the controller 20 may adjust the amount of opening/closing of the flow path opening/closing valve 16 according to the output range of the fuel cell stack 2. The controller 20 may output a control signal so as to close the flow path opening/closing valve 16 when a control signal associated with a low-output range is issued, output a control signal so as to at least partially open the flow path opening/closing valve 16 when a control signal associated with an intermediate-output range according to the output value is issued, and output a control signal so as to completely open the flow path opening/closing valve 16 when a control signal associated with high-output range is issued.

Now, referring to FIG. 3, a humidifying method of the fuel cell according to the exemplary embodiment of the present invention will be described. In particular, to assembly the apparatus, a hollow fiber membrane module 14 is disposed inside the housing 12 of the humidifying apparatus 10. The first inlet 26 and the first outlet 28 are formed in both side surfaces of the housing 12, and the second inlet 30 and the second outlet 32 are formed in one side and the other side of the outer circumferential surface of the housing 12. The flow path opening/closing valve 16 formed of the solenoid valve employing the duty-control method may be mounted in the first outlet 28.

To control the apparatus, a sensor 18 senses a control factor, which is any one of the amount of current of the fuel cell stack 2, the amount of applied pressure of the accelerator pedal, and humidity of the inlet of the fuel cell stack 2, and based on a sensing signal generated by the sensor 18 and sent to the controller 20, the controller 20 determines a range to which output of the fuel cell stack 2 belongs. This range can be the low-output range, the intermediate-output range, and the high-output range. Upon determining this range, the controller then transmits a control signal to the flow path opening/closing valve 16 to control the flow path accordingly.

As stated above, the amount at which the flow path opening/closing valve 16 is opened is controlled according to the control signal from the controller 20. When flow path opening/closing valve 16 receives a control signal associated with the low-output range the valve 16 is completely closed. When the flow path opening/closing valve 16 receives a control signal within the intermediate range, the valve is is duty-controlled according to the output value of the fuel cell stack 2 to gradually open the valve 16. Finally, when the flow path opening/closing valve 16 receives a control signal associated with the high-output range, the valve 16 is completely opened.

As illustrated in FIG. 3A, when the fuel cell stack 2 has a low output, the air inside the housing 12 of the humidifying apparatus 10 flows with a low flow rate and low pressure and the flow path opening/closing valve 16 is closed. In addition, dry air supplied from an air blower 4 flows toward an outer side of the hollow fiber membrane module 14, so that humidification mainly occurs in an outer portion of the humidifying apparatus 10.

Further, as illustrated in FIG. 3B, when the fuel cell stack 2 has intermediate output, as the output value of the flow path opening/closing valve 16 is increased, the dry air is gradually diffused to the entire of the hollow fiber membrane module 14 while the flow path opening/closing valve 16 is gradually opened by the duty control.

Further, as illustrated in FIG. 3C, when the fuel cell stack 2 has high output, the air inside the housing 12 of the humidifying apparatus 10 flows with a high flow rate and high pressure and the flow path opening/closing valve 16 is completely opened, and the dry air flows toward the entire hollow fiber membrane module 14, so that humidification is performed over the entire area of the humidifying apparatus 10.

According to the aforementioned configuration, the humidifying apparatus 10 of the fuel cell according to the exemplary embodiment of the present invention improves humidifying performance within the entire hollow fiber membrane module 14, thereby efficiently adjusting humidity of the fuel cell stack 2.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 2: Fuel cell stack | 4: Air blower |
| 10: Humidifying apparatus | 12: Housing |

| 14: Hollow fiber membrane module | |
|---|---|
| 16: Flow path opening/closing valve | |
| 18: Sensor | 20: Controller |

| | |
|---|---|
| 26: First inlet | 28: First outlet |
| 30: Second inlet | 32: Second outlet |

What is claimed is:

1. A humidifying apparatus of a fuel cell, comprising:
a hollow fiber membrane module disposed inside a housing, the housing provided with a first inlet and a first outlet formed in both side surfaces of an outer circumferential surface thereof, and a second inlet and a second outlet formed at one side and an opposite side thereof;
a valve mounted in the first outlet;
a sensor configured to sense a control factor of a fuel cell stack, generate a signal; and
a controller configured to output a control signal that adjusts an amount the valve according to the signal generated by the sensor.

2. The humidifying apparatus of claim 1, wherein:
the control factor is selected from a group consisting of an amount of output current from the fuel cell stack, an amount of applied pressure on an accelerator pedal, and a humidity of the inlet of the fuel cell stack.

3. The humidifying apparatus of claim 2, wherein:
the sensor is selected from a group consisting of a current sensor that senses the amount of output current of the fuel cell stack, a pedal sensor that senses the amount of applied pressure on the accelerator pedal, and a humidity sensor that senses humidity of the inlet of the fuel cell stack.

4. The humidifying apparatus of claim 1, wherein:
the valve is a solenoid valve employing a duty control method.

5. The humidifying apparatus of claim 1, wherein:
the controller outputs a control signal associated with a low-output range when output of the fuel cell is less than about 30 kw, a control signal associated with an intermediate-output range when output of the fuel cell is about 30 to 60 kw, and a control signal associated with a high-output range when output of the fuel cell is about 60 to 100 kw, based on 100 kw of output of the fuel cell.

6. The humidifying apparatus of claim 5, wherein:
the controller includes control logic that completely closes the valve by issuing a control signal associated with the low-output range to force dry air flow toward an outer side of the hollow fiber membrane module.

7. The humidifying apparatus of claim 5, wherein:
the controller includes control logic that gradually opens the valve via duty-control according to the control signal associated with the intermediate-output range.

8. The humidifying apparatus of claim 5, wherein:
the controller includes control logic that completely opens the valve by the control signal associated the high-output range to force the dry air flow toward an entire area of the hollow fiber membrane module.

9. A humidifying method of a fuel cell, comprising:
disposing a hollow fiber membrane module, in which a plurality of hollow fiber membranes is densely collected, inside the housing;
forming a first inlet and a first outlet in both side surfaces of the housing;
forming a second inlet and a second outlet at both sides of an outer circumferential surface of the housing; and
mounting a valve in the first outlet,
wherein a controller adjusts how much the valve is opened or closed based upon a signal received from a sensor, the signal generated based on a control factor of the fuel cell stack to adjust humidity of the fuel cell stack.

10. The humidifying method of claim 9, wherein:
the control factor is selected from a group consisting of an amount of output current of the fuel cell stack, an amount of applied pressure of an accelerator pedal, and a humidity of the inlet of the fuel cell stack.

11. The humidifying method of claim 9, wherein:
the controller outputs a control signal associated with a low-output range when output of the fuel cell is less than about 30 kw, a control signal associated with an intermediate-output range when output of the fuel cell is about 30 to 60 kw, and a control signal associated with a high-output range when output of the fuel cell is about 60 to 100 kw, based on 100 kw of output of the fuel cell.

12. The humidifying method of claim 11, wherein:
the controller completely closes the valve issuing a control signal associated with the low-output range to force dry air flow toward an outer side of the hollow fiber membrane module.

13. The humidifying method of claim 11, wherein:
the controller duty-controls how much the valve is opened by issuing the control signal associated with the intermediate-output range in order to gradually open the valve.

14. The humidifying method of claim 11, wherein:
the controller completely opens the valve by issuing the control signal associated the high-output range to force the dry air flow through an entire area of the hollow fiber membrane module.

15. A humidifying method of a fuel cell, comprising:
sensing, by one or more sensors, a control factor associated with an output of a fuel cell stack;
generating, by the sensor, a signal based upon the control factor;
transmitting, by the sensor, the signal to a controller configured to control a valve mounted in an outlet of a housing having within a hollow fiber membrane module, in which a plurality of hollow fiber membranes are densely collected; and
adjusting how much the valve is opened or closed based upon the signal received from the sensor.

16. The humidifying method of claim 15, further comprising:
outputting, by the controller, a control signal associated with a low-output range when output of the fuel cell is less than about 30 kw;
outputting, by the controller, a control signal associated with an intermediate-output range when output of the fuel cell is about 30 to 60 kw; and
outputting a control signal associated with a high-output range when output of the fuel cell is about 60 to 100 kw, based on 100 kw of output of the fuel cell.

17. The humidifying method of claim 16, further comprising completely closing, by the controller, the valve by issuing a control signal associated with the low-output range to force dry air flow toward an outer side of the hollow fiber membrane module.

18. The humidifying method of claim 16, further comprising duty-controlling how much of the valve is opened by issuing the control signal associated with the intermediate-output range in order to gradually open the valve.

19. The humidifying method of claim 16, further comprising completely opening, by the controller, the valve by issuing the control signal associated the high-output range to force the dry air flow through an entire area of the hollow fiber membrane module.
